(19) United States
(12) Patent Application Publication
(10) Pub. No.: US 2008/0024836 A1
(43) Pub. Date: Jan. 31, 2008

(54) Digital Sensor Whole Image Scanning Device

(76) Inventor: John Phillip Sundnes, (US)

Correspondence Address: JOHN PHILLIP SUNDNES, 23342 PARK SORRENTO, CALABASAS, CA, 91302-1738, US

(21) Appl. No.: 11/830,847

(22) Filed: Jul. 31, 2007

Related U.S. Application Data
(60) Provisional application No. 60/834,335, filed on Jul. 31, 2006.

(51) Int. Cl. H04N 1/04

(52) U.S. Cl. 358/474

(57) ABSTRACT

A digital scanning device 22 (FIGS. 1-7) whereby a digital camera infrastructure 12 is utilized as the primary element to “scan” objects. The scanned object 21 is placed on a translucent plate 14 and the controls 13 are activated initiating the scan. It is possible to arrange the controls, such that pressure on the scanning device 22 affirms the object to be scanned 21 is on the device and initiates the scan function in a fluid motion. The camera assembly 12 captures the scanned image 23 and either a) sends it to digital storage assembly 24, b) sends it to a computer assembly 25, c) sends it to a printer assembly 26, d) sends it to a fax machine assembly 30, e) sends it to a viewing device assembly 36.

### RELATED APPLICATIONS

This application claims the benefit of provisional patent application No. 60/834335 filed Jul. 31, 2006 by the present inventor.

### CROSS REFERENCES TO RELATED APPLICATIONS

None.

### FEDERALLY SPONSORED RESEARCH

None.

### SEQUENCE LISTING

None.

### FIELD OF INVENTION

This invention pertains to scanning devices, such as currently available computer scanners, facsimile scanners, photocopier scanners, etc. Virtually all currently available “scanners” rely on physical movement of the scanned object past a scanning element (generally an elongated digital sensor and an elongated light source). This physical movement requires motors, gears, paper handlers, etc. and imposes scanning speed limits based on the physics of the mechanical movement required. All the added hardware to create the movement requires added expense and complication of the scanner.

My proposed invention is essentially fixing a digital camera element in a “scanner” casing, to replace all the elongated sensors, light bars, gears, and motors. This invention takes advantage of the fact that currently available digital cameras have all the electronic capability of capturing an entire image in an instant, instead of line by line as in typical scanners. This negates the need for movement for scanning objects, allowing the entire scanning device to be much simpler. Further, currently available scanners routinely generate a computer file format such as a jpeg file. This is also the preferred file format resulting of a digital camera.

Fast shutter operations of digital cameras can capture a clear, still image of an object in motion with relative ease, and currently available cameras can capture multiple still images at several frames per second. This same technology, coupled with currently available sheet feeders, could allow extremely rapid scanning of multi-page documents, as the individual documents fly past the scanner lens without stopping, and the lens taking high speed images of the documents in mid movement (similar to a camera taking still pictures of running athletes).

The whole image scan taken by a digital camera creates a computer file that can be instantly stored, printed, or converted into other files suitable for other applications or even faxing. A line by line analysis of the computer file (if required) is much more quickly completed by a computer algorithm than it is by both the physical movement and the line by line image capture from the elongated sensor bars of typical scanners today.

### DESCRIPTION OF PRIOR ART

Previous versions of scanners fall into several problem areas. First, are scanners or facsimiles that utilize a cumbersome Charge Coupled Device (CCD) sensor. Second are scanners or facsimiles that utilize a somewhat simplified Contact Image Sensor ((CIS) consisting of rows of red, green, and blue light emitting diodes to scan the document). Third are photocopiers utilizing photo receptor drums, photo conducting platens, substantial amounts of light and movement, and heat toner fusing elements. All of these require physical movement of an object past the scanning element to produce a viable scan. This movement limits the scanning speed to the physical movement, and requires motors, gears, stabilizers, etc. which add to the expense and complication of the device. Also, this movement requires either the object being scanned or the scanning element to remain motionless while the other component passes by it.

The Charge Coupled Device (CCD) scanner requires many thousands of sensors, an elongated light source, and a mechanical movement to produce a scan. In many cases, these scanners require multiple passes of the scanned object to produce high resolution color scans. For higher resolution scans, a vastly large number of sensors in a single CCD array are required. A scanner claiming 4800×4800 dots per inch resolution would need over 40,000 sensors in the elongated CCD bar. The required movement requires significant amounts of energy and time to complete, not to mention the expensive motors, gears, and stabilizers. Also, the information from the sensor is fed to the a computer a line at a time, which means that movement of the scanned object during scanning ruins the scan, and that the resulting computer file of the scan cannot be completed until the physical movement of the scan is completed. This makes the scanning event extremely slow. Examples of these types of scanners with refinements can be found in Mr. Yamaguchi's U.S. Pat. No. 4,651,221 and Mr. Chen's U.S. Pat. No. 4,809,062.

The Contact Image Sensor (CIS) scanner is very similar in operation and limitations to the CCD scanner. The CIS scanning element consists of rows of red, green, and blue light emitting diodes to scan the document (in an elongated bar format), and mechanical movement to produce a viable scan. This places limitations on speed of file creation, and the limitations of holding the scanned object still during the scanning process similar to the CCD scanning device. Examples of these types of scanners with refinements can be found in Mr. Sheng's U.S. Pat. No. 5,801,851 and Mr. Hwang's U.S. Pat. No. 5,187,596.

A typical photocopier utilizes photoreceptor drums, photo conducting platens, substantial amounts of light and movement, and heated toner fusing elements to produce copies. These “scanners” essentially create copied images from an extreme light source, placing ink via negatively and positively charged toner and paper. After the ink is placed, heat is required to fuse the elements (paper and toner) together to produce the copy. This process is usually faster than the CCD or CIS scanner process, but does not allow for digital files to be created of the original documents. This process is mainly suited to creating paper only copies of images. Examples of these types of reproduction devices can be found in Mr. Schrempp's U.S. Pat. No. 3,984,241 and Mr. Jahn's and Mr. Brunkel 's U.S. Pat. No. 4,219,272.

All of these scanners in the referenced patents suffer from essentially the same limitations. They require physical movement of a scanned object past a scanning element. First, this greatly limits the speed at which scans can be completed. Second, it requires elongated light bars and scanning elements, which can be expensive and complicated. Third, the movement requires gears, motors, and stabilizers, which furthers the expense and complication of manufacturing, and requires substantial energy to complete.

None of these scanners can capture an image in the fraction of an instant the way a digital camera sensor can, with a single burst of light from a potentially small light source. None of these scanners can provide a viewfinder on the exterior of the scanner to depict the same image the sensor lens is viewing (under a cover), to aid in alignment of the scanned object prior to scanning, and to “proof” the image following the scan.

In conclusion, insofar as I am aware, there are no computer scanning, facsimile scanning, copy scanning, thumbprint scanning, or other typical office type scanning devices currently available that utilize a digital camera as the primary image capture element.

### OBJECTS AND ADVANTAGES

Accordingly, several objects and advantages of the present invention are:
(1) The “scan” operation happens in an instant with whole image capture, as fast as the fastest camera shutter.
(2) Line by line computer file information can be derived electronically from a whole image file much faster than an object can be physically moved past a narrow sensor bar. This provides a much higher speed of file creation, and subsequent file manipulation.
(3) There is no need to move scanned objects or scanning elements relative to each other in perfect alignment to create a scan. Objects can be immediately captured in an instant without movement.
(4) There can be extremely rapid multiple scans with document feeders. Documents do not need to stop on their way past the lens, as moving documents are captured by high speed shutters.
(5) The energy required for the actual scan is greatly reduced, by eliminating motors, gears, and elongated scanning sensors and light bars. Similar to existing digital cameras, small batteries and storage chips allow the capture of hundreds or thousands of images. This allows for new portable scanners, not required to be hooked up to computers. Many scans can be completed and saved for later use by computers, printers, etc.
(6) The fabrication of the scanning device is greatly simplified and more economical by eliminating motors, gears, stabilizers, and elongated scanning sensors and light bars.
(7) The parts in the scanner can be fixed to create scanners that are “tougher” for field operations.
(8) There is no need for the object to be scanned to be fixed for a period of time. This allows thumb scans, object scans, or scans in moving vehicles.
(9) Scanners could use auto focus beams and optical lenses to adjust for different sized objects.
(10) Scanners could use multiple sensors to adjust for different proportioned objects.
(11) Scanners could use multiple digital camera sensor assemblies, to allow scanning speeds to double or more depending on the number of assemblies and the sequence of scanning.

### SUMMARY OF THE INVENTION

In accordance with the present invention I propose a new scanning device to rapidly and efficiently create images of objects, by combining existing digital camera technology in a new and novel way. I propose a casing, similar to existing scanning device casings (a plastic box), with a sheet of translucent material to hold the scanned object. Within the casing is a digital camera photo sensor (i.e. Foveon sensors, Color filter array sensors, Active Pixel sensors, etc.), with a light source and a shutter such that a light source and an open shutter can create an image on the sensor in an instant. The sensor, shutter, and related optics would be focused to the image size on the translucent plate (object holder), and could have an adjustable lens to scan large or small objects on the translucent plate. Also within the casing is a power source (battery or plug in), a means of digital storage (RAM or ROM), and a means to convey the digital files created to another device (i.e. a USB® connection with a computer, fax, printer, etc.).

Another improvement of the invention (not required but recommended for added function) is to wire a typical electronic camera viewfinder (like Liquid Crystal Displays currently found on digital cameras) on the exterior surface of the scanner. This shows the actual alignment of the scanned object as it's being placed on the translucent plate, prior to scanning, to aid alignment. This viewfinder would also show a preview of the scan immediately after scanning, prompting the user to choose whether to use that scan or create another.

This new means of “scanning” objects is also very efficient, and scanners could be battery operated, portable, and scan and save images for later upload to computers or printers. Current digital camera technology can capture thousands of images on a small battery charge and a small memory chip.

Multiple digital camera sensors can be utilized to make the machine even more efficient, or flatter. A single small sensor chip may require substantial depth to the scanner casing to get the focal perspective of the larger image to be scanned. Smaller sensor chips arranged in a fixed pattern relative to one another may take snapshots of smaller areas of a single object at the same time, and stitch them together to a single file or image, by utilizing typical digital camera “photo stitch” technology.

A single “add on” sensor chip could be activated to stitch on the elongated part of a legal sized document when compared to a letter sized document. This may be required since a legal document is of different proportions than a letter sized document. Larger images of the same proportions (i.e. 8×11″ to 11×17″) can be produced by changing the focal lens of the prime sensor to the plane of translucent material.

An alternative embodiment would involve multiple photo sensors in a line, so that documents moving quickly past could receive alternating scans from multiple sensors. This arrangement could double the speed of the fastest camera shutter currently available.

An alternative embodiment would also include a printing mechanism, similar to existing ink jet or laser jet printers currently available, and potential paper sorting and stapling devices. The scanning parameters would be selected from the controls, and the data from the scans would be sent directly to printer(s), whereby the copies would be sorted and stapled similar to typical copiers currently available. This device would likely exceed the speeds of copiers currently available, as a stack of documents could be “scanned” as quickly as they can be moved past the sensor lens, with the files being sent to one or a series of internal printers printing the images as quickly as possible. The scanning operation and the printing operation could also be completely disconnected, allowing multiple users to scan in their print jobs quickly, and later return for the finished printed copies.

Another alternative embodiment would utilize this device to “scan” an image into a computer processor, where the computer processor quickly and electronically breaks down the “instant” scanned file information line by line, instead of waiting for the line by line information to be captured by the thin elongated scanning bar as in typically facsimile machines today. The “whole image capture” scan could be instantly captured, quickly broken down by a computer algorithm, and transmitted over the phone lines faster than typical fax machines today.

The scanning process could further be simplified by utilizing the translucent plate or the scanner lid as the “scan activation” control. For example, a thumbprint scanner could have a user place his/her thumb down on the translucent plate and depress the translucent plate, thus aligning the scanned object and activating the scan in one fluid motion. Another example would be to place a document down on a translucent plate, close the lid, while simultaneously depressing the lid against an integral “activate scan” button, in one fluid motion, thus activating the scan function.

### BRIEF DESCRIPTION OF DRAWINGS

FIG. 1 depicts the scanning device assembly with the integral internal digital camera sensor apparatus inside, replacing the sensor bar, light bar, and all motorized elements.

FIG. 2 depicts a cutaway section of the apparatus at location 13 of FIG. 1, showing the casing in section, the lid, the digital photo/image apparatus, and the relation of the image focal area to the translucent plane. This figure also depicts an adjustable lens to change the parameters of the scanned area via changing the focus of the lens.

FIG. 3 depicts a cross section of a scanner with an “add on” sensor to adjust for objects that are larger or smaller with dissimilar proportions (i.e. 8.5×11″ to 8.5×14″, where the add on sensor picks up 8.5×3″ stitched to the main sensor file that is 8.5×11″).

FIG. 4 depicts a cross section of a scanner with a document feeder assembly, and multiple photo sensors. It is possible with this arrangement to have a continuous stream of fast moving documents from the document feeder, captured by alternating sensors (sensor 1, sensor 2, sensor 1, sensor 2 etc.) to double the fastest speed of the sensors shutter time. This embodiment is well suited to a device designed for large quantity document back up.

FIG. 5 depicts a flow chart of a whole object scan in operation, where by a document is captured on the digital sensor, and sent either to electronic storage, a computer, a printer, an electronic monitor/display, etc. FIG. 3 also depicts the computer algorithm creating an instant code breakdown of the image, making the file suitable for use by a facsimile, or other device.

FIG. 6a and FIG. 6b depicts the typical operation of a currently available scanner, where the narrow elongated sensor bar collects information from an object one line at a time via physical movement, and conveys the information to a computer for reassembly and processing.

FIG. 7 depicts the same invention applied to a large copier, with the digital photo sensor in place of the elongated scanning elements, and laser or ink jet printers in place of charged photo platens and heated drums. The paper trays, paper sorting, stapling, controls, etc. could all still be similar to a typical copier. Also depicted is the viewing screen, which would assist users in placing or aligning specific copies, by displaying the internal sensors view of the object to be scanned to the user.

### DRAWINGS—REFERENCE NUMERALS

The following are referenced numerals in the drawings:
10. Exterior casing of the device.
11. Device lid.
12. Digital photo/sensor device, with all typical elements of a common digital camera (digital sensor, shutter, optical sensor(s)
13. Control panel for the device
14. Translucent plane for holding objects to be scanned.
15. Printer assembly (ink jet, laser, etc.).
16. Paper sorting tray assemblies.
17. Paper supply tray assemblies.
18. Larger office copy unit.
19. Lens focal parameter.
20. Power Cord.
21. Object to be scanned.
22. Digital sensor whole image scanning device
23. Computer image/file of scanned object.
24. Memory chip or device
25. Computer.
26. Printer.
27. Email document.
28. Computer Algorithm to convert the computer file format, or break down the file to line by line information if required (i.e. for faxing).
29. Machine language representation of the initial computer file after being analyzed by the algorithm.
30. Fax machine.
31. Single line of object being scanned by a light bar and scanning bar (typical scanning device operation for comparison (not part of this invention).
32. Machine language representation of the single line of information scanned (typical scanning device operation for comparison (not part of this invention).
33. Arrow depicting mechanical movement of either scanning device, or of scanned object to procure line by line machine code representation of the object being scanned (typical scanning device operation for comparison (not part of this invention).
34. Adjustable Lens unit for adjusting focal parameter to different sized objects to be scanned on translucent plane.
35. Adjusted focal parameter.
36. Electronic viewing device.
37. Automatic document feeder.
38. Step one parameters of multi stage document scanning utilizing multiple digital camera sensors.
39. Step two parameters of multi stage document scanning utilizing multiple digital camera sensors.
40. Arrow depicting movement of documents past the sensors on from the automatic document feeder.

### DETAILED DESCRIPTION OF DRAWINGS (RE-WRITE)

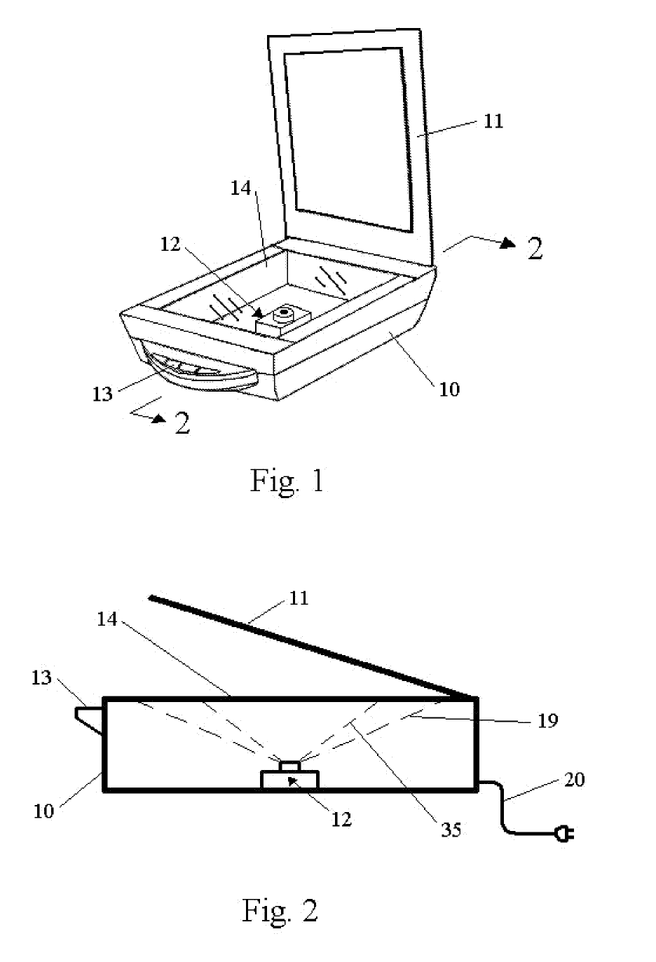

### FIGS. 1 and 2 Preferred Embodiment

FIG. 1 depicts the scanning device assembly with the exterior casing 10, integral internal digital camera sensor apparatus 12 inside, replacing the sensor bar, light bar, and all motorized elements. Also depicted is the translucent plate 14 for holding scanned objects in relative position to the digital sensor, external controls 13 for operating the unit, and the optional lid/cover 11 for the device.

FIG. 2 depicts a cutaway section of the assembly. This figure shows the casing 10 in section, the lid 11, a power source 20 (note this could be plug in or internal battery source), the digital photo/image apparatus 12, and the relation of the image focal area 19 to the translucent plane 14. This figure also depicts the changed focal area 35 on the translucent plane by changing the focus of the camera lens.

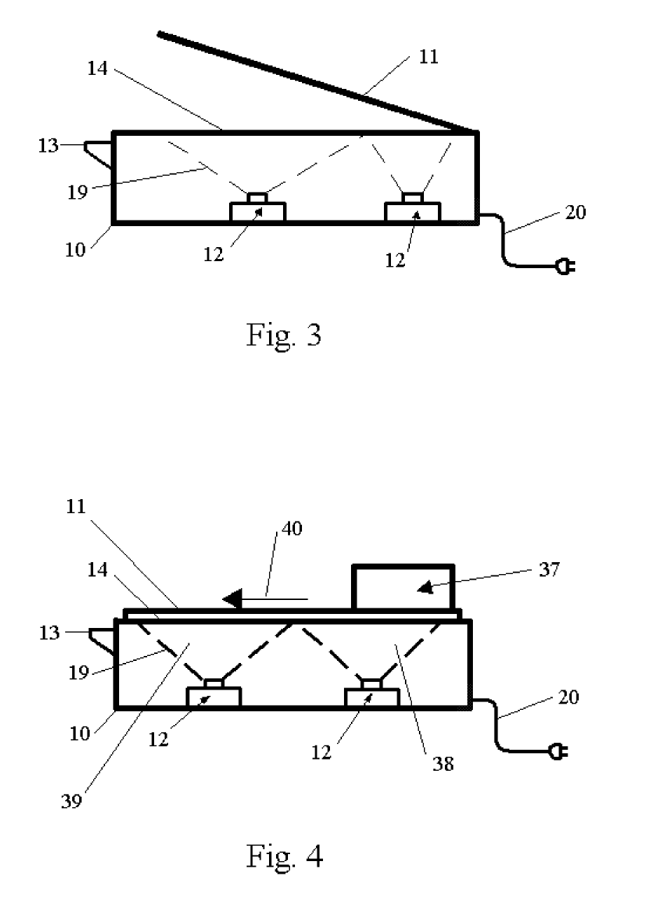

### FIGS. 3 and 4 Additional Embodiments

FIG. 3 depicts a cross section of an additional embodiment scanner with similar elements to that depicted in FIG. 2, showing the casing 10, the lid 11, a power source 20, and a digital photo/image apparatus 12. This embodiment depicts an additional sensor 12 as may be necessary to adjust for objects that are larger or smaller with dissimilar proportions (i.e. 8.5×11″ to 8.5×14″, where the add on sensor picks up 8.5 x 3” stitched to the main sensor file that is 8.5×11″).

FIG. 4 depicts a cross section of an additional embodiment scanner with similar elements to that depicted in FIG. 2, showing the casing 10, the lid 11, a power source 20, and a multitude of digital photo/image apparatuses 12. This embodiment also shows a document feeder assembly 37. It is possible with this embodiment to have a plurality of scanners (2, 4, 6, etc.) to capture scans of larger documents and combine the areas of the scans to form a single file. It is also possible with this arrangement to have a continuous stream of fast moving documents from the document feeder, captured by alternating sensors (first sensor 38, second sensor 39, first sensor 38, second sensor 39, etc.) to double the fastest speed of an individual sensors shutter time. The flow of objects to be scanned is depicted in direction 40. This embodiment is well suited to a device designed for large quantity document back up and continuous operation.

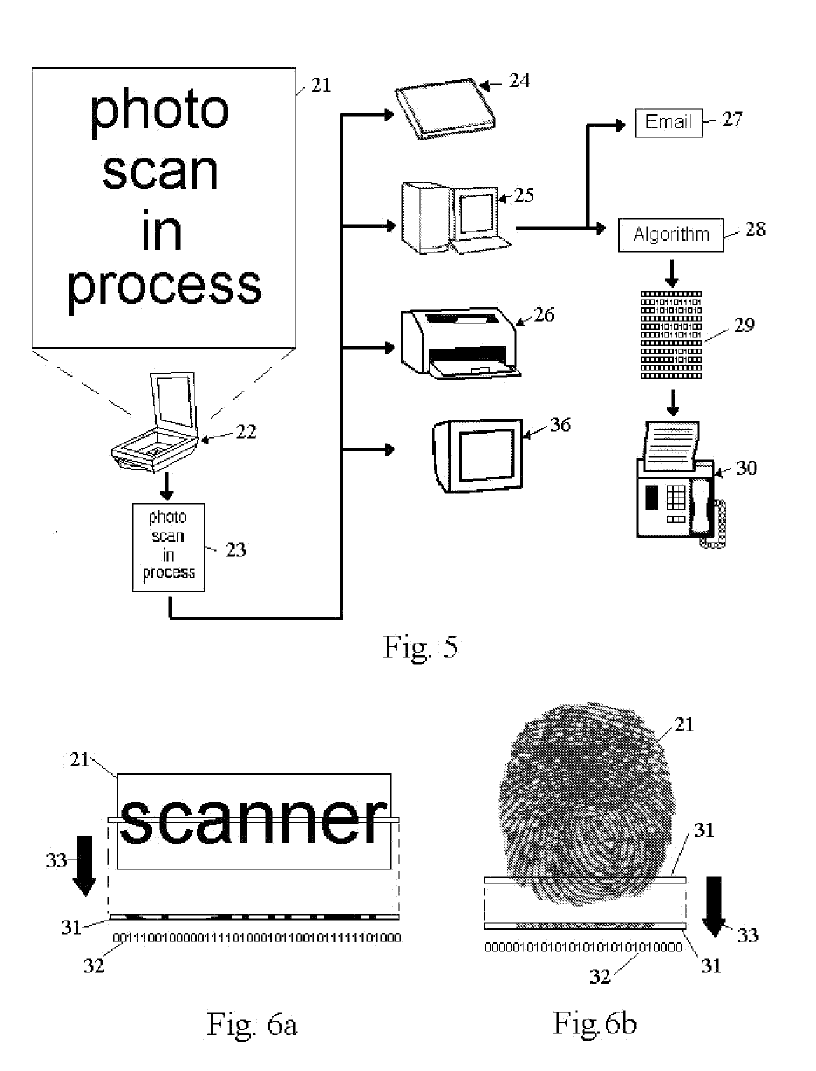

### FIGS. 5, 6a, and 6b—Operation

FIG. 5 depicts a flow chart of a whole object scan in operation, where by an object/document 21 is captured on the digital sensor scanning device assembly 22. The resulting computer file 23 is sent either to electronic storage medium assembly 24 (i.e. Random Access Memory, Read Only Memory, etc.), a computer processing unit assembly 25, a printer assembly 26, or an electronic monitor/display 36. Sending the file to a computer processing unit assembly 25 allows the file to be processed for email 27, or broken down via an algorithm 28 for transmission to a fax machine 30. If the recipient of the file (fax, computer, printer, etc.) requires a line by line coding 29 of the image, a computer algorithm aligns the image, and analyzes the line by line values. The computer is much quicker at performing this function electronically than a light bar and sensor bar mechanically passing over the image.

FIG. 6a (not part of this invention) depicts the typical operation of a currently available scanner, where a sensor bar collects information from a document/object 21 one line 31 at a time via physical movement 33, and conveys the information 32 to a computer or fax machine for reassembly and processing.

FIG. 6b (not part of this invention) also depicts the typical operation of a currently available scanner, where a sensor bar collects information from a different type of document/object 21 one line at a time 31 via physical movement 33, and conveys the information 32 to a computer or fax machine for reassembly and processing.

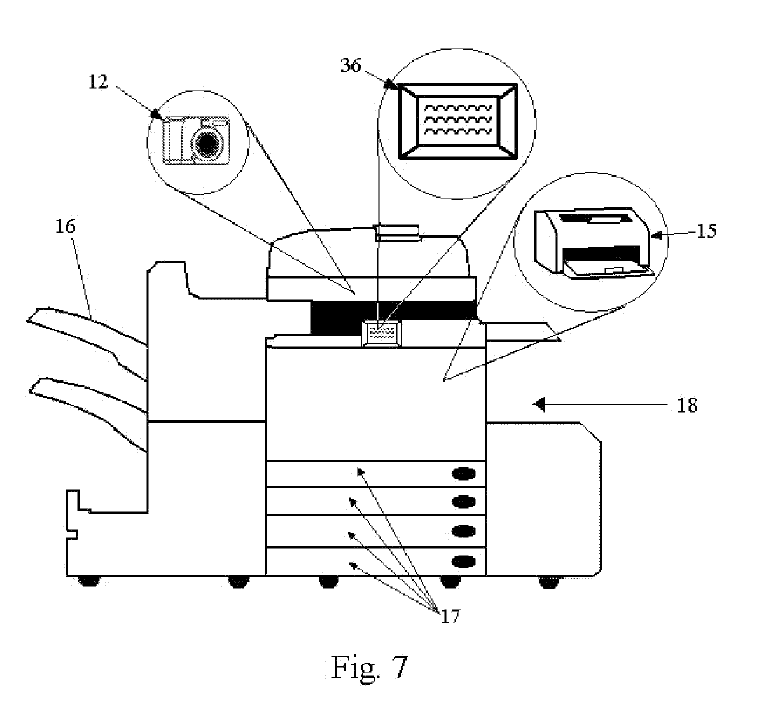

### FIG. 7—Alternative Embodiment

FIG. 7 depicts a typical large copier assembly 18, with the internal digital camera sensor apparatus 12, the internal printer assembly(ies) 15, an optional external viewfinder 36, typical paper supply trays 17, and paper sorting trays 16.

### Advantages

From the description above, a number of advantages of my digital whole image scanning device become evident:
a) The device is simple. It is specifically designed to take advantage of the relatively inexpensive and simple digital camera designs currently available, and utilize them in a new and novel way as powering document scanners in the work place. The simple digital camera arrangement eliminates the need for expensive gears, motors, stabilizing bars, and elongated sensors and lights.
b) The device is fast. This device utilizes current camera technology that can capture a document in a split second. Most current scanners take several seconds to produce a scan, and higher resolution can take minutes or longer.
c) The device is inexpensive. This device utilizes technology that is relatively inexpensive, and the lack of motors and gears reduces manufacturing costs.
d) The device is hardy. The lack of motors and gears means scanning devices could be manufactured to take shocks and jolts, and take viable scans in a split second if the entire scanner is moving (like if used in a vehicle, boat, etc.).
e) The device is power efficient. The lack of motors and gears, and the split second action time of the scanning operation substantially reduces the amount of power needed to produce a viable scan.

Accordingly, the reader will see that the digital sensor whole image scanning device is a substantial improvement and novel new use of currently available technology. The device can be used in a number of applications, but would prove especially useful in typical office activities. The device scans an object in an instant, leaving computer algorithms to breakdown the information, eliminating the requirement for the scanned object to sit still for a period of time while scanned objects physically move past scanning elements. This makes the device well suited to scanning thumbprints or the like, where some movement may ruin typical scans. The device has the possibility of taking multiple scans of an object as it moves through a paper feeding cycle (like a business class copy machine) allowing the copier to either correct images not on track or stop the scanning process until the paper is put back on track. Utilizing multiple sensors in succession would also allow the scanning process speeds to double or more the fastest shutter speeds (by alternating camera sensor devices), depending on how many sensors are working in succession. This device lends itself to real time sample images of the scanned object on an electronic viewfinder, allowing face down images to be precisely aligned prior to scanning. This device also lends itself to greatly speeding up the entire process of scanning for offices, emailing, copying, and even faxing. As the modern offices of the world move closer and closer to paperless systems, there are numerous opportunities to take existing objects and reduce them to electronic storage. This device is designed to take advantage of this growing need. Furthermore, as the world moves to ever increasing security, the device can also be utilized to take instant images of identification cards/badges, credit cards, thumbprints, etc.

Although the description above contains much specificity, the specific details provided should not be construed as limiting the scope of the invention, but as merely providing illustrations of some of the presently preferred embodiments of this invention.

What is claimed is:

1. A digital scanning device to capture images of objects, comprising:
a) at least one exterior casing,
b) at least one means of holding a scanned object in relative position to the device,
c) at least one digital camera sensor
d) at least one aperture
e) at least one light source
f) at least one power source
g) at least one means to activate and control the scanning process
h) at least one means to store the information -OR- convey the digital information to another device.

2. An electronic viewing device for viewing pre-scan images comprising:
a) an electronic display
b) a means to connect the digital camera sensor view with the electronic display.

3. An ability to remove the camera device from the scanner device for independent use, comprising:
a) at least one scanner casing assembly
b) at least one digital camera assembly.

4. A means to scan via depressing the scanner itself, comprising:
a) at least one scan activation control
b) a means to activate the control via depressing the object on the scanner -OR-
a means to activate the control via depressing the cover of the scanner
